(19) United States
(12) Patent Application Publication
(10) Pub. No.: US 2010/0314932 A1
(43) Pub. Date: Dec. 16, 2010

(54) AUTOMOBILE WHEEL

(75) Inventors: Noriyuki Fukaya, Anjo-shi (JP); Yoshiyuki Nyuunoya, Anjo-shi (JP); Katsuya Chashiro, Anjo-shi (JP); Atsuhiko Jinno, Anjo-shi (JP); Satoru Nakamura, Anjo-shi (JP)

Correspondence Address: DARBY & DARBY P.C., P.O. BOX 770, Church Street Station, New York, NY, 10008-0770, US

(73) Assignee: Central Motor Wheel Co., Ltd., Anjo-shi (JP)

(21) Appl. No.: 12/446,415

(22) PCT Filed: Nov. 22, 2006
(86) PCT No.: PCT/JP2006/323326

§ 371 Date: Apr. 20, 2009

(51) Int. Cl. B60B 3/04

(52) U.S. Cl. 301/63.101

(57) ABSTRACT

In a disc of an automobile wheel, a plurality of hub surface rounded portions are formed at intervals on an imaginary circle provided around a hub hole and centered on an imaginary center corresponding to the center of the hub hole. The hub surface rounded portions are provided with a compressive residual stress by a compression process for work hardening. The strength of the hub surface rounded portions can thus be improved.

### CROSS-REFERENCE TO PRIOR APPLICATION

This is the U.S. National Phase Application under 34 U.S.C. §371 of International Patent Application No. PCT/JP2006/323326 filed Nov. 22, 2006, which is incorporated by reference herein. The International Application was published in Japanese on May 29, 2008 as WO2008/062521 A1 under PCT Article 21(2).

### FIELD OF THE INVENTION

The present invention relates to a hub surface rounded portion formed on a disc of an automobile wheel.

### BACKGROUND OF THE INVENTION

There are well known two-piece automobile wheels made by fitting a substantially circular disc with the inner peripheral surface of a substantially cylindrical rim and joining the fitted portion.

In a two-piece automobile wheel a, as shown in FIG. 19, a rim b includes rim flanges c, c at both the opening edges of the rim b for supporting beads of a tire (not shown) from a side. Bead seats d, d, on which the beads of the tire are seated, are formed continuously inside the respective rim flanges c, c to extend substantially in parallel to the axis of the rim b. A drop portion e which is dented toward the radially inner side of the rim b is formed between the bead seats d, d.

Meanwhile, as shown in FIGS. 19 and 20, a disc f includes a hub hole g formed in the center and a plurality of bolt holes h disposed around the hub hole g on the same circle at regular intervals. A nut seat i is formed around the opening of each bolt hole h. A hat j projecting toward the design surface side is formed at an intermediate portion between the radially outer portion of each nut seat i and the outer peripheral edge of the disc f. A hub surface rounded portion m, which slightly projects toward the design surface back side, is formed between a bolt hole forming surface r in which the bolt holes h are formed (see FIG. 20) and a rising inclined surface k of the hat j. A hub attachment surface p, which contacts a hub (not shown) of an automobile, is formed on the design surface back side of the hub surface rounded portion m. In order to obtain a heat dissipation effect, the hat j includes a plurality of ornamental holes q arranged circumferentially at regular intervals. The outer side of the hat j is bent toward the design surface back side to form a flange n capable of being fitted with the inner peripheral surface of the drop portion e of the rim b. Wheels with the above-described constitution shown in FIG. 19 include the rim b and the disc f fitted at the drop portion e, and may be called “drop fitting wheels” (see Japanese Unexamined Patent Publication No. 2004-74248, for example).

As two-piece automobile wheels other than the drop fitting wheels, there are also known so-called “full-face wheels” (see Japanese Unexamined Patent Publication No. H08-183301, for example). In a full-face wheel, a rim includes a design surface back side flange for supporting a bead of a tire from a side at one end in the axial direction, and a joint at the other end. The outer periphery of a disc serves as a design surface side flange for supporting the other bead of the tire from a side. The back of the disc is joined to the joint of the rim so that the disc and the rim are integrated with each other.

As two-piece automobile wheels other than those discussed above, there are also known so-called “bead fitting wheels”. In a bead fitting wheel, a rim includes bead seats, at both sides in the axial direction, on which the beads of a tire are seated, and one of the bead seats serves as a fitting bead seat. A disc is fitted with the fitting bead seat, and the fitted portion is joined so that the disc and the rim are integrated with each other.

While discs of automobile wheels discussed above have been proposed with various external shapes, for example with a variety of sizes, designs and arrangements of ornamental holes, depressions and projections on the design surface, and so forth, the shape of the hub surface rounded portion is roughly divided into two types. In one type, as shown in FIG. 20, the ornamental holes are formed to be relatively small, and a single hub surface rounded portion m that is substantially annular as viewed from the front is formed around the hub holes. In the other, as shown in FIG. 21, the edges of the ornamental holes q project toward the hub hole g so that the surrounding portions of the ornamental holes q split the hub surface rounded portion m. In other words, a plurality of hub surface rounded portions m are formed separately at intervals on an imaginary circle s provided around the hub hole g and centered on an imaginary center corresponding to the center of the hub hole g. Automobile wheels with the above-described constitution, in which the edges of the ornamental holes q project toward the hub hole g, are more novel in design, and have a higher heat dissipation effect, than the type shown in FIG. 20.

In the disc constitution that is formed with a single hub surface rounded portion in the substantially annular shape as viewed from the front (see FIG. 20), the entire hub surface rounded portion contacts a hub of an automobile, and therefore the load applied to the disc is distributed to the entire disc uniformly. In the constitution in which a plurality of hub surface rounded portions are formed at intervals (see FIG. 21), the hub surface rounded portions contact a hub with a smaller area than in the above-described constitution. In addition, it is difficult for the load applied to the disc to be distributed to the entire disc, and thus the hub surface rounded portions are subjected to large loads. If large loads are applied to the hub surface rounded portions, the hub surface rounded portions and the surrounding areas are subjected to stress concentration, and wheels with the constitution may not be able to achieve satisfactory results in a prescribed service life test (lateral load endurance test). Specifically, the wheels were cracked at half the number of revolutions specified by requirements in the service life test, making it extremely difficult to introduce the wheels to the market.

It is therefore an object of the present invention to provide an automobile wheel that includes a disc in which a plurality of hub surface rounded portions are formed at intervals and that still provides a desired service life.

### SUMMARY OF THE INVENTION

The present invention provides an automobile wheel having a rim on which a tire is mountable and a disc joined to the rim, in which the disc includes a hub hole disposed centrally of the disc and a plurality of hub surface rounded portions for contacting a hub of an automobile, the hub surface rounded portions being formed at intervals on an imaginary circle provided around the hub hole and centered on an imaginary center corresponding to a center of the hub hole, and all the hub surface rounded portions are provided with a compressive residual stress by a compression process for work-hardening.

In a disc in which hub surface rounded portions are formed at intervals, conventionally, the hub surface rounded portions are subjected to stress concentration, and thus a desired service life may not be obtained when the disc is used in an automobile wheel. In the present invention, meanwhile, all the hub surface rounded portions are provided with a compressive residual stress by a compression process for work-hardening, improving the strength of the hub surface rounded portions to reliably provide a desired service life.

In a conventional constitution, if a compressive residual stress is provided to a part of a disc, the disc may be distorted to deteriorate the circularity of the automobile wheel. In the present invention, however, a compressive residual stress is provided to all the hub surface rounded portions of a disc on purpose, improving the strength of the hub surface rounded portions while maintaining the circularity of the automobile wheel.

In the above constitution, the following compression processes may be proposed.

In the case where the disc is shaped by pressing a base material in a predetermined shape into a predetermined shape using a pair of shaping dies, as the compression process for work-hardening the hub surface rounded portions, there may be proposed a pressing process including obtaining a disc in a predetermined shape and applying a high pressure to all the hub surface rounded portions.

In such a constitution, all the hub surface rounded portions are work-hardened in the pressing process for forming a disc into a predetermined shape. Therefore, the number of processes for producing a disc is not increased compared to a conventional technique, achieving a disc productivity that is as high as a conventionally technique. Since shaping dies are used for the processing, the hub surface rounded portions are not wounded to spoil the design quality. Therefore, in the case where a disc is shaped by a pressing process for work-hardening the hub surface rounded portions, it is possible to restrain the production of paint defectives with a poor design quality, even if the design surface side of the hub surface rounded portions is painted as it is without being polished. In the pressing process, a higher pressure may be applied to the hub surface rounded portions than to the surrounding areas of the hub surface rounded portions, or a higher pressure may be applied to the hub surface rounded portions than to other portions of the disc, with the pressure adjusted appropriately.

As the compression process for work-hardening the hub surface rounded portions, there may be proposed a shot peening process performed on the hub surface rounded portions.

According to such a constitution, all the hub surface rounded portions can be work-hardened using a known technique. In the case where a shot peening process is applied only to the design surface back side of all the hub surface rounded portions, the design surface side is not wounded to be rough, and the design quality is not spoiled. In the case where a shot peening process is applied only to the design surface side of all the hub surface rounded portions, the strength of the hub surface rounded portions can be improved more than the case where a shot peening process is applied only to the design surface back side.

There may also be proposed a constitution in which the disc includes bulged projections formed between the hub surface rounded portions that are adjacent to each other in a direction along the imaginary circle provided around the hub hole, the bulged projections projecting to a design surface side with respect to the hub surface rounded portions and partially extending inwardly of the imaginary circle.

In such a constitution, the hub surface rounded portions and the bulged projections are formed alternately in the direction along the imaginary circle, creating an elevation difference in the axial direction of the disc on the imaginary circle. Thus, while conventionally the hub surface rounded portions at a low elevation are subjected to so large stress concentration as to be occasionally cracked or the like, all the hub surface rounded portions are provided with a compressive residual stress in the present invention, improving the strength to provide a desired service life.

In the above constitution, the disc may be configured such that a gear-shaped annular surface is formed inside the imaginary circle provided around the hub hole, with bolt holes formed circumferentially at regular intervals in the gear-shaped annular surface, and the hub surface rounded portions are formed at swelling arcuate portions constituting a part of an outer periphery of the gear-shaped annular surface.

In the disc including such a gear-shaped annular surface, a plurality of hub surface rounded portions are disposed at intervals, which has conventionally been problematic in terms of strength. In the present invention, however, all the hub surface rounded portions are provided with a compressive residual stress, improving the strength to provide a desired service life.

The automobile wheel in accordance with the present invention may be configured as follows.

An outer periphery of the disc may serve as a design surface side flange for supporting a bead of a tire from a side, the rim may include a design surface back side flange for supporting a bead of the tire from a side at one end of the rim in an axial direction, and a joint at the other end, and a back surface of the disc may be joined to the joint. Automobile wheels with such a constitution are so-called “full-face wheels”.

The rim may include bead seats, at both sides of the rim in an axial direction, on which beads of a tire are seated, with one of the bead seats serving as a fitting bead seat, and the disc may be fitted with the fitting bead seat. Automobile wheels with such a constitution are so-called “bead fitting wheels”.

In providing the hub surface rounded portions with a compressive residual stress by a compression process, a compressive residual stress may be provided not only to the hub surface rounded portions but also to the neighboring surrounding areas. For example, there may be proposed a constitution in which the disc includes the hub surface rounded portions and outer rising portions formed continuously with outer peripheral sides of the hub surface rounded portions and inclined to the design surface side with respect to the hub surface rounded portions, and all the hub surface rounded portions and all the outer rising portions are provided with a compressive residual stress by a compression process for work-hardening.

With such a constitution, the strength of all the hub surface rounded portions and all the outer rising portions can be improved, providing an automobile wheel including a further sturdy disc.

The automobile wheel in accordance with the present invention includes a disc in which a plurality of hub surface rounded portions are formed at intervals, with all the hub surface rounded portions provided with a compressive residual stress by a compression process for work-hardening. Therefore, the strength of the hub surface rounded portions can be improved while maintaining the circularity, providing a desired service life.

In the above constitution, in the case where the compression process is a pressing process including obtaining a disc in a predetermined shape and applying a high pressure to all the hub surface rounded portions, the compression process in accordance with the present invention can be performed in an existing pressing process for obtaining a disc in a predetermined shape. Therefore, the strength of all the hub surface rounded portions can be improved while maintaining the disc productivity without increasing the number of production processes compared to a conventional technique. Since shaping dies are used for the pressing process, the hub surface rounded portions are not wounded to spoil the design quality.

In the case where the compression process is a shot peening process performed on the hub surface rounded portions, all the hub surface rounded portions can be subjected to a compression process and provided with a compressive residual stress by suitably adopting a known technique.

In the case where bulged projections partially extending inwardly of the imaginary circle provided around the hub hole are formed between the hub surface rounded portions of the disc, the problem associated with the related art, that the hub surface rounded portions are subjected to stress concentration to result in insufficient strength, can be solved to obtain an automobile wheel providing a desired service life.

In the case where a gear-shaped annular surface is provided and the hub surface rounded portions are formed at swelling arcuate portions of the gear-shaped annular surface, the problem associated with the related art, that the hub surface rounded portions are subjected to stress concentration to result in insufficient strength, can be solved to obtain an automobile wheel providing a desired service life.

In the case where an outer periphery of the disc serves as a design surface side flange for supporting a bead of a tire from a side, the rim includes a design surface back side flange for supporting a bead of the tire from a side at one end of the rim in an axial direction, and a joint at the other end, and a back surface of the disc is joined to the joint, the present invention can be applied to full-face wheels.

In the case where the rim includes bead seats, at both sides of the rim in an axial direction, on which beads of a tire are seated, with one of the bead seats serving as a fitting bead seat, and the disc is fitted with the fitting bead seat, the present invention can be applied to bead fitting wheels.

In the case where all the hub surface rounded portions and all the outer rising portions are provided with a compressive residual stress by a compression process for work-hardening, there can be provided an automobile wheel in which the strength of all the hub surface rounded portions and all the outer rising portions is improved.

### BRIEF DESCRIPTION OF THE DRAWINGS

FIG. 1 is a vertical cross sectional view showing an automobile wheel 1a in accordance with an embodiment, taken along the line A-A of FIG. 2.

FIG. 2 is a front view of the automobile wheel 1a including a disc 3a.

FIG. 3 is a front view of the disc 3a showing an imaginary circle 26.

FIG. 4 is a vertical cross sectional view showing a pressing process for finally obtaining the shape of the disc 3a.

FIG. 5 is an enlarged photograph showing a vertical cross section of a hub surface rounded portion 20.

FIG. 6 is an enlarged photograph showing a portion α, in which a shows an article of the embodiment and b shows a conventional article.

FIG. 7 is an enlarged photograph showing a portion β, in which a shows the embodiment article and b shows the conventional article.

FIG. 8 is an enlarged photograph showing a portion γ, in which a shows the embodiment article and b shows the conventional article.

FIG. 9 is an enlarged photograph showing a portion δ, in which a shows the embodiment article and b shows the conventional article.

FIG. 10 is an enlarged photograph showing a portion ε, in which a shows the embodiment article and b shows the conventional article.

FIG. 11 is an enlarged photograph showing a portion ζ, in which a shows the embodiment article and b shows the conventional article.

FIG. 12 is an enlarged photograph showing a portion η, in which a shows the embodiment article and b shows the conventional article.

FIG. 13 is a vertical cross sectional view showing an automobile wheel 1b in accordance with another embodiment, taken along the line B-B of FIG. 14.

FIG. 14 is a front view of the automobile wheel 1b including a disc 3b.

FIG. 15 is a front view of a disc 3c in accordance with a further embodiment.

FIG. 16 is a vertical cross sectional view taken along the line C-C of FIG. 15.

FIG. 17 is a front view of a disc 3d in accordance with an embodiment.

FIG. 18 is a vertical cross sectional view taken along the line D-D of FIG. 17.

FIG. 19 is a vertical cross sectional view showing an automobile wheel a with a conventional constitution.

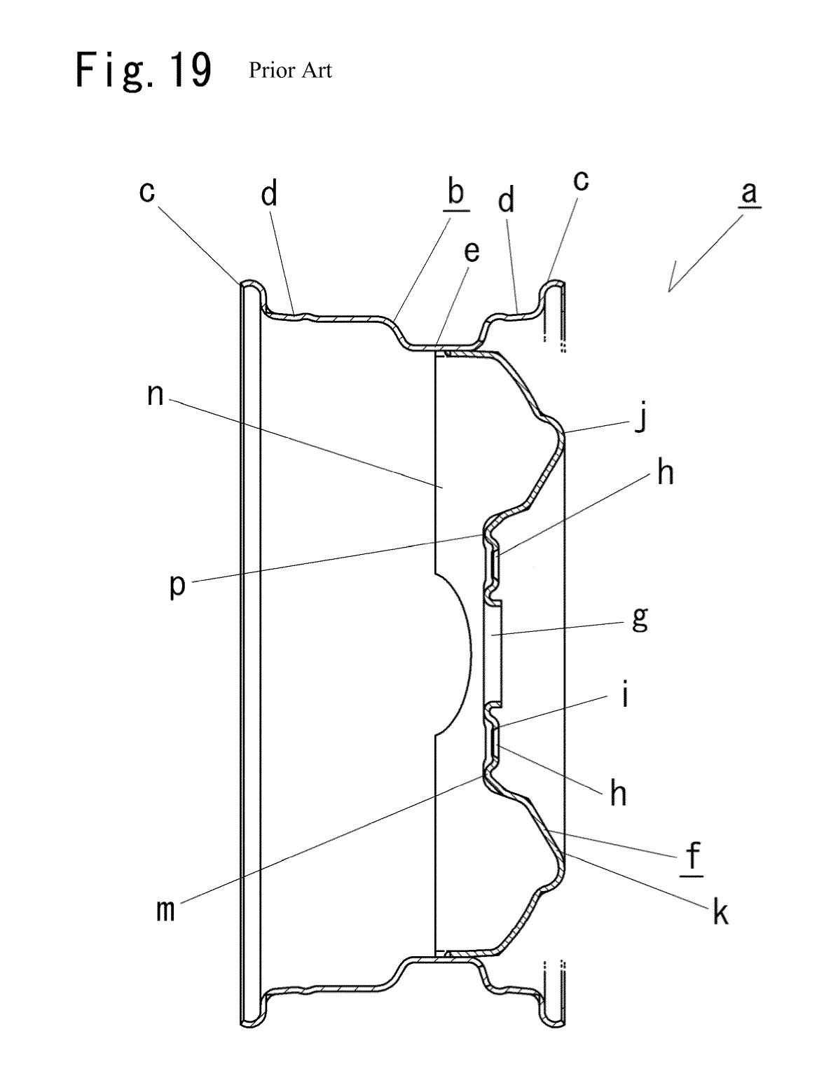

FIG. 20 shows a perspective view showing a disc f with a conventional constitution.

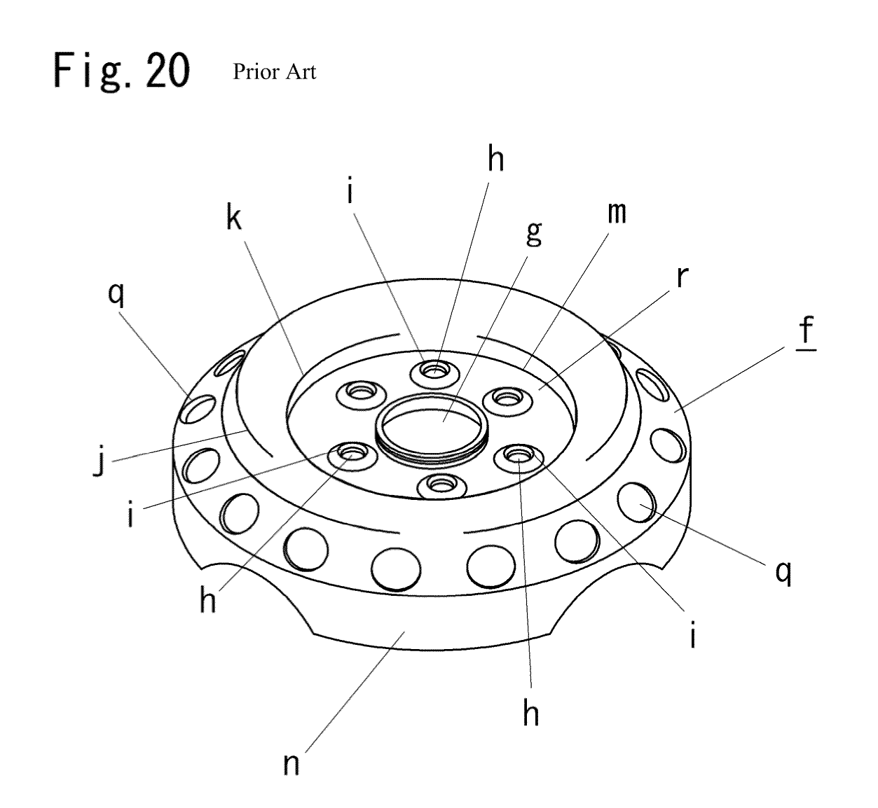

FIG. 21 shows a front view showing a disc f with a conventional constitution.

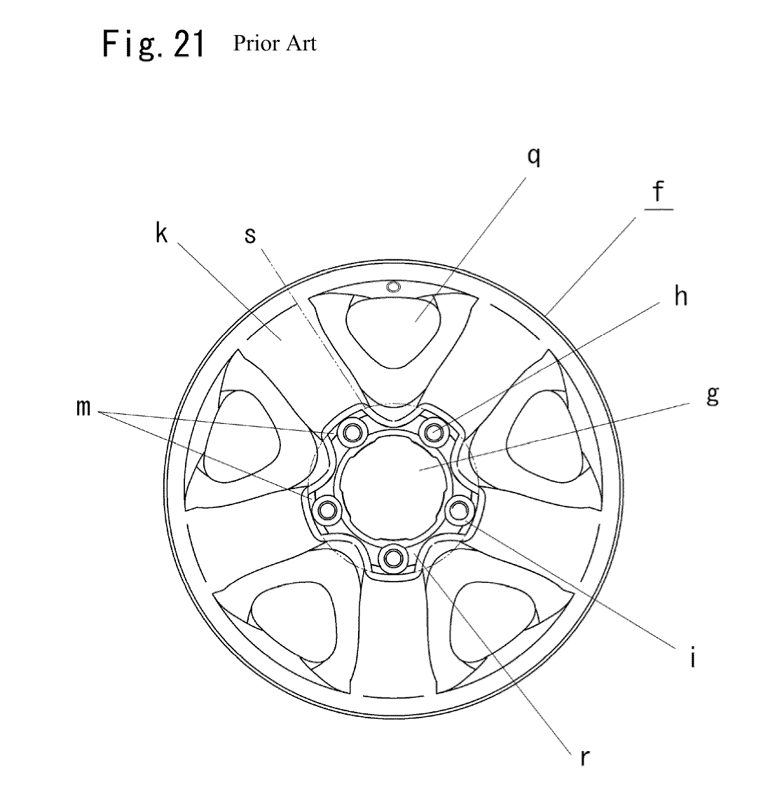

### DETAILED DESCRIPTION OF THE INVENTION

An automobile wheel 1a in accordance with the present invention will be described using a full-face wheel as an example.

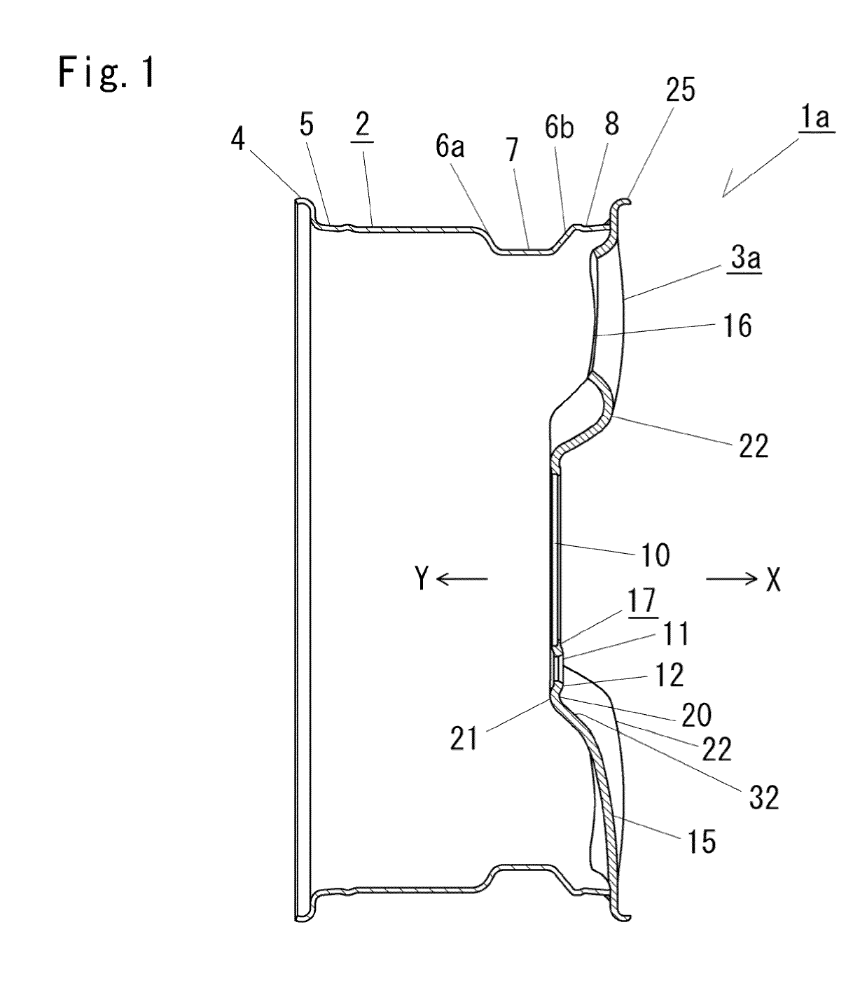

As shown in FIG. 1, the automobile wheel 1a includes a substantially cylindrical rim 2 on which a tire is mountable, and a disc 3a in the shape of a substantially circular plate, which are integrated with each other.

The rim 2 is described below.

As shown in FIG. 1, the rim 2 includes a design surface back side flange 4, at the inner end which is on the side of an automobile (not shown), for supporting a bead (not shown) of a tire from a side. An inner rim bead seat 5, on which the bead (not shown) of the tire is seated, is formed continuously with the design surface back side flange 4. A drop portion 7 is formed centrally of the inner peripheral surface of the rim 2 via an inner well 6a, which is formed continuously with the inner rim bead seat 5. The drop portion 7 is used, when mounting a tire, to drop a bead of the tire.

The rim 2 is also formed with a design surface side bead seat 8 (joint) via an outer well 6b, which is formed continuously with the drop portion 7. A bead of a tire is also seated on the design surface side bead seat 8.

The disc 3a is described below.

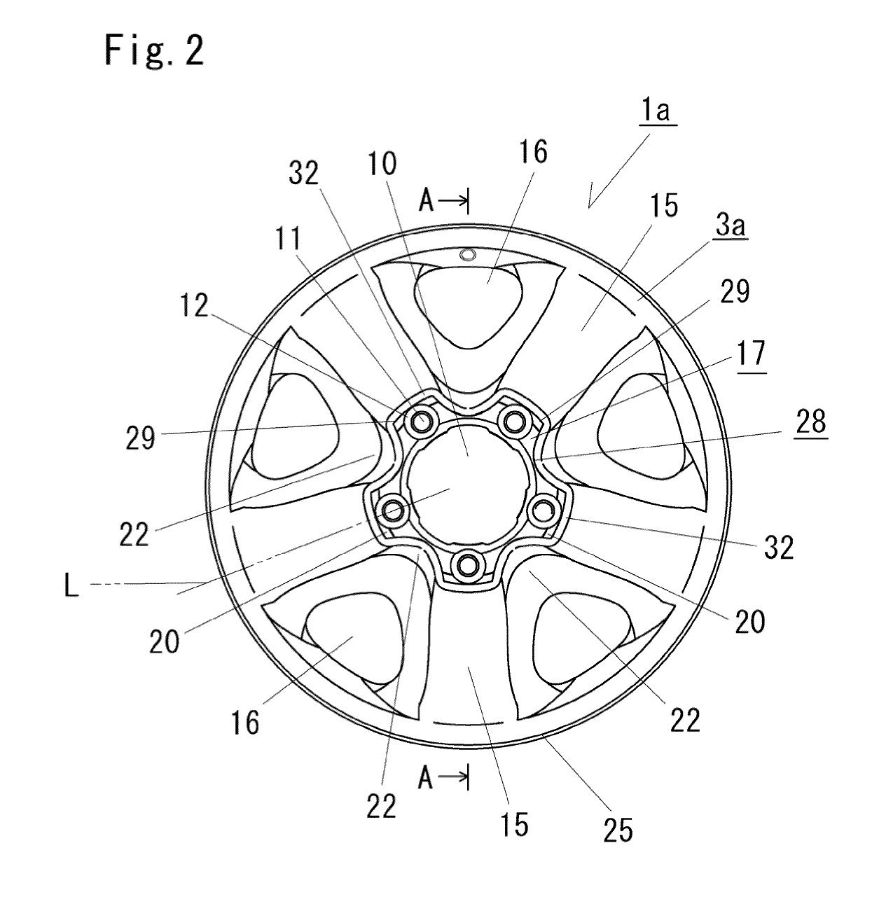

As shown in FIGS. 1 and 2, the disc 3a in the shape of a circular plate includes a hub hole 10 penetrating the center of the disc 3a in the axial direction of the disc 3a. A bolt hole forming surface 17 is formed around the hub hole 10 to surround the hub hole 10. Five bolt holes 11 are formed in the bolt hole forming surface 17 and disposed on the same circle at regular intervals. The bolt hole forming surface 17 is perpendicular to the axial direction of the disc 3a. A nut seat 12 is provided for each bolt hole 11 to surround the opening of the bolt hole 11 and swell to the design surface side X (in the direction of the arrow X in FIG. 1) with respect to the bolt hole forming surface 17.

Five spokes 15 are formed to extend radially from around the radially outer side of each nut seat 12 to the outer peripheral edge of the disc 3a. Ornamental holes 16 are formed between the spokes 15 in the circumferential direction. A design surface side flange 25 is formed at the outer periphery of the disc 3a by bending the outer peripheral edge of the disc 3a toward the design surface side X. The design surface side flange 25 supports a bead of a tire from a side.

A hub surface rounded portion 20, which slightly projects to the design surface back side Y (in the direction of the arrow Y in FIG. 1), is arranged between each bolt hole forming surface 17 and each spoke 15 in the radial direction of the disc 3a. A hub attachment surface 21 (see FIG. 1), which contacts a hub (not shown) of the automobile, is formed on the design surface back side of each hub surface rounded portion 20.

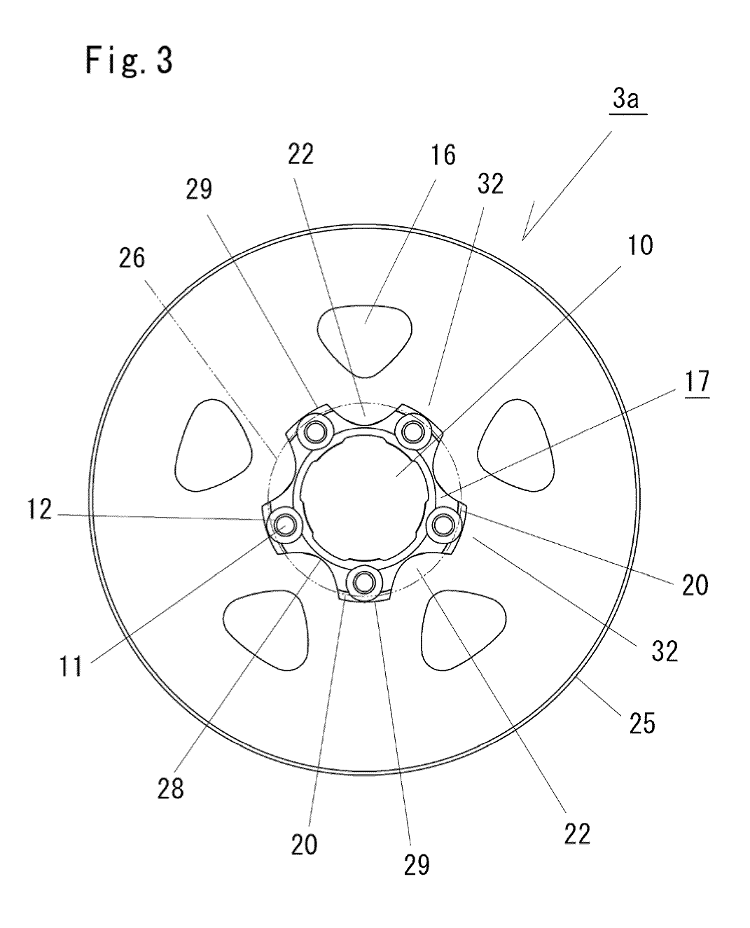

According to the embodiment, five hub surface rounded portions 20 are formed at regular intervals on an imaginary circle 26 (see FIG. 3) provided around the hub hole 10 and centered on an imaginary center corresponding to the center of the hub hole 10. In FIG. 3, projections and depressions associated with the spokes 15, the ornamental holes 16 and bulged projections 22 are not depicted for convenience of illustration. As shown in FIGS. 1 and 2, bulged projections 22, which project to the design surface side X to a predetermined height with respect to the hub surface rounded portions 20, are disposed between adjacent hub surface rounded portions 20, 20 on the imaginary circle 26. More specifically, the bulged projections 22 are formed along the ornamental holes 16, and portions of the bulged projections 22 on the hub hole 10 side extend to the inner region of the imaginary circle 26. With the bulged projections 22 between the hub surface rounded portions 20 formed to swell toward the hub hole 10, projections and depressions are formed in the circumferential direction of the imaginary circle 26, providing an external shape with high-quality design with an elevation difference between the hub surface rounded portions 20 and intervening portions.

The automobile wheel 1a in which the rim 2 and the disc 3a are integrated with each other may be constructed by welding a portion of the design surface back side in the vicinity of the design surface side flange 25 and the design surface side bead seat 8 of the rim 2, as shown FIG. 1. Suitable welding methods include known fillet welding such as arc welding and laser welding.

The external shape of the disc 3a may be suitably obtained by a known pressing process.

More specifically, the disc 3a is produced by performing a plurality of pressing processes (punching process, preliminary drawing process, shape drawing process, restriking process, and coining process) on a plate-like steel base material. For example, a substantially square and flat alloy steel plate is first prepared, and the four corners of the plate are punched in an arcuate shape so as to convex outward. Then, in the preliminary drawing process, the plate is formed into a dish-like intermediate material having a recess as a circular hole in the central region. Then, in the shape drawing process, the intermediate material is formed into a disc-shaped article formed with the nut seats 12, the hub surface rounded portions 20 and so forth. Then, in another drawing process, the dimensional accuracy of the disc-shaped article is adjusted. Then, in the restriking process, the design surface side flange 25 is formed. Then, in the coining process as the final process, the bolt holes 11 are finished. The number of processes to produce the disc 3a is not limited to thereto.

An essential portion of the present invention is described below.

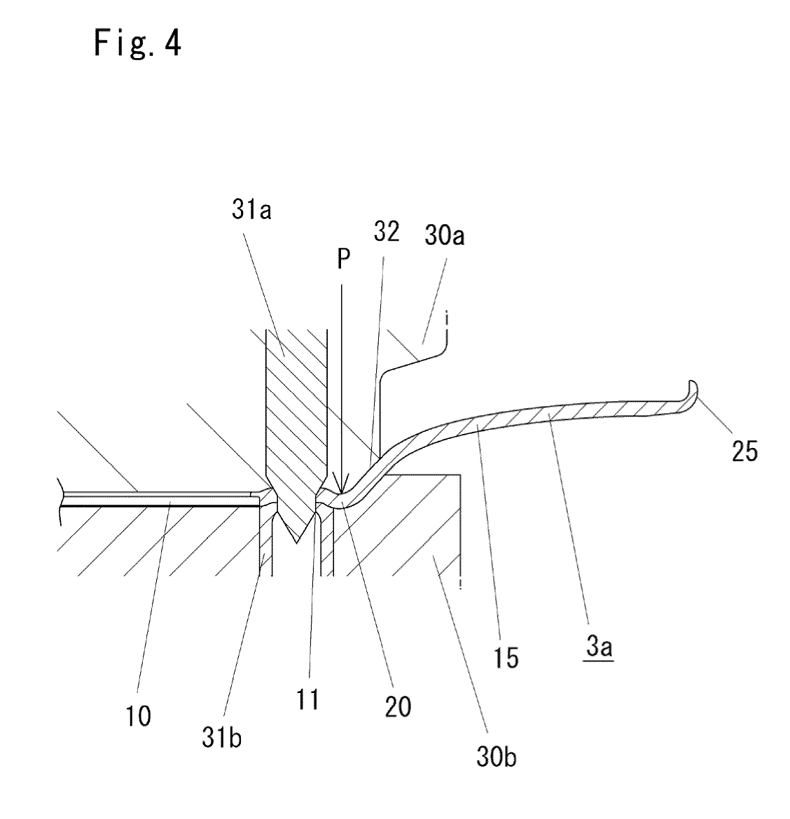

According to the present invention, a high pressure is applied to all the hub surface rounded portions 20 of the disc 3a in the axial direction of the disc 3a in the coining process. More specifically, as shown in FIG. 4, the bolt hole 11 is finished using a coining punch 31a and a coining die 31b, and a predetermined pressure P is applied to all the hub surface rounded portions 20 in the axial direction of the disc 3a using an upper die 30a (shaping die) and a lower die 30b (shaping die), in the coining process.

By applying a higher pressure to all the hub surface rounded portions 20 than to other portions, the hub surface rounded portions can be made thinner than a conventional technique and work-hardened. Such work-hardening provides all the hub surface rounded portions 20 with a compressive residual stress, improving the strength of the hub surface rounded portions 20 while maintaining the circularity of the automobile wheel 1a. A high pressure may be applied to all the hub surface rounded portions 20 in pressing processes other than the coining process. Thus, a high pressure may not necessarily be applied to all the hub surface rounded portions 20 in the final process.

A description is made of evaluation of the hub surface rounded portions 20 provided with a compressive residual stress.

A comparison was made between a disc in which the hub surface rounded portions 20 had been provided with a compressive residual stress and a conventional article in which a compressive residual stress had not been provided, focusing on the plate thickness of the hub surface rounded portions. The hub surface rounded portions of the conventional article, to which a high pressure had not been applied, had a plate thickness of approximately 6.171 mm, while the hub surface rounded portions of the article of the embodiment, to which a high pressure had been applied, had a plate thickness of approximately 6.140 mm. Thus, the hub surface rounded portions 20 of the embodiment article were made thinner than the conventional article by approximately 0.031 mm.

The discs were compared focusing on the hardness of the hub surface rounded portions (using a Vickers hardness test method). The hub surface rounded portions of the conventional article had a hardness of approximately 222.1 (parent material hardness: 193.6). Meanwhile, the hub surface rounded portions 20 of the embodiment article had a hardness of approximately 233.1 (parent material hardness: 199.9). Thus, the hub surface rounded portions 20 of the embodiment article had a higher hardness than that of the hub surface rounded portions of the conventional article, even with the parent material hardness taken into account. From the above, it is considered that the hub surface rounded portions 20 were positively work-hardened by the above pressing process. When the hub surface rounded portion 20 of the disc 3a as the embodiment article was cut from the radially outer portion toward the center (see the chain double-dashed line L of FIG. 2) using a contour machine (band saw) to prepare a test piece, a phenomenon was observed in which the cut surfaces would close after the cutting blade passed. This indicates that a compressive residual stress remained in the hub surface rounded portions 20 of the disc 3a. Such a phenomenon was not observed with the conventional article.

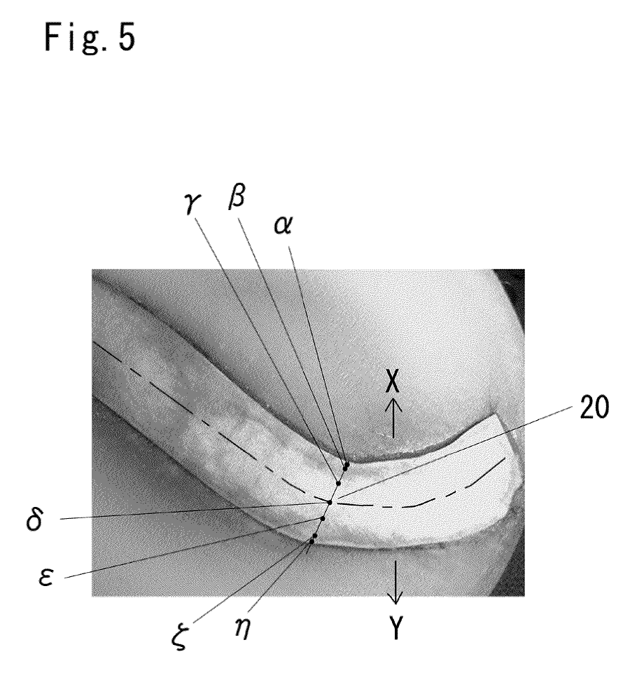

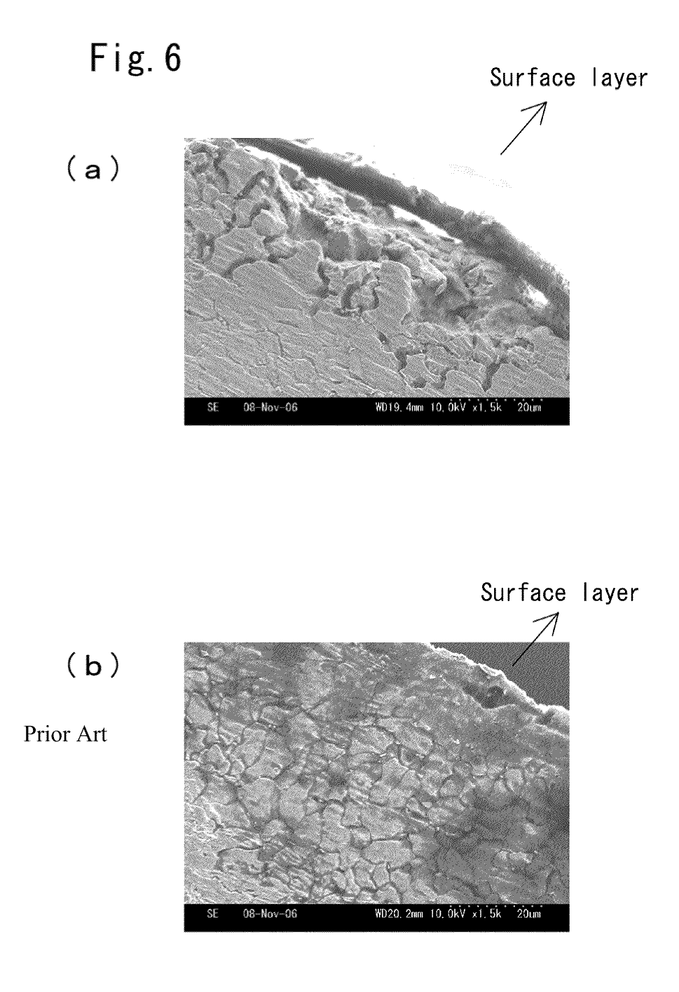

Then, the discs were compared focusing on the metal texture of the hub surface rounded portions. As shown in FIG. 5, measurement was performed at the surface layers (portion α and portion η), portions at a depth of about 0.1 mm from the surface layers (portion β and portion ζ), portions at a depth of about 1.5 mm from the surface layers between the surface layers and the plate thickness center (portions γ and portion ε), and the plate thickness center at a depth of about 3.2 mm from the surface layers (portion δ). The textures at the portions α to η were as shown in FIGS. 6 to 12. The magnification of the photographs is about 1500.

<portion α>

In the disc 3a of the embodiment article, as shown in FIG. 6a, metal particles were dense and had a compressed shape at the surface layer. Meanwhile, in the conventional disc, as shown in FIG. 6b, metal particles were sparse and not compressed at the surface layer. By the evaluation at the portion α, it was found that the gap between metal particles was changed by the high pressure applied in the present invention.

### <Portion β>

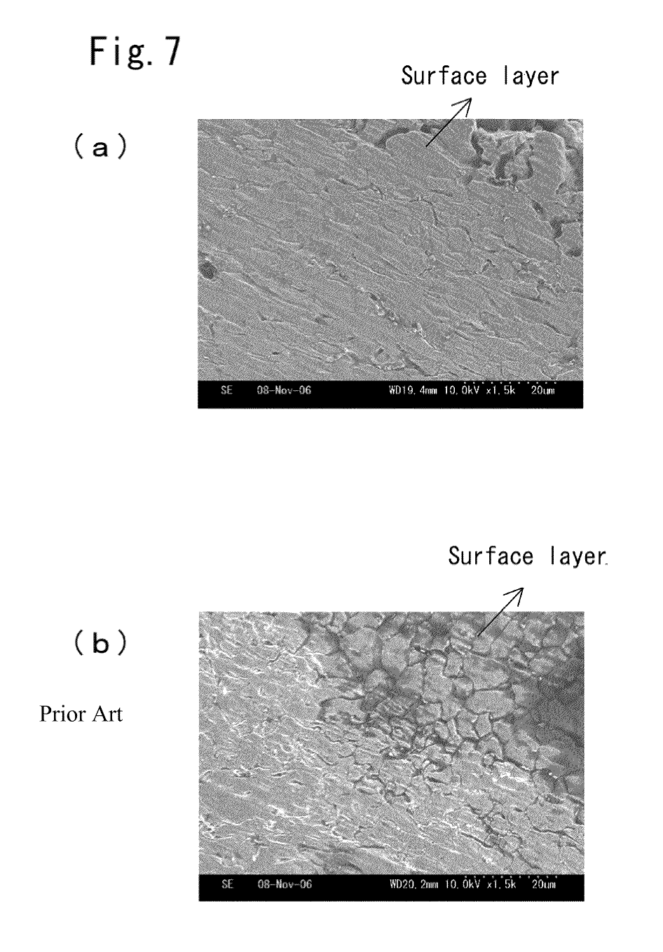

In the embodiment article, as shown in FIG. 7a, metal particles were compressed. Meanwhile, in the conventional disc, as shown in FIG. 7b, particles were not compressed at the portion close to the surface layer. By the evaluation at the portion β, it was found that the gap between particles and the shape of particles were changed by the high pressure applied in the present invention.

### <Portion γ>

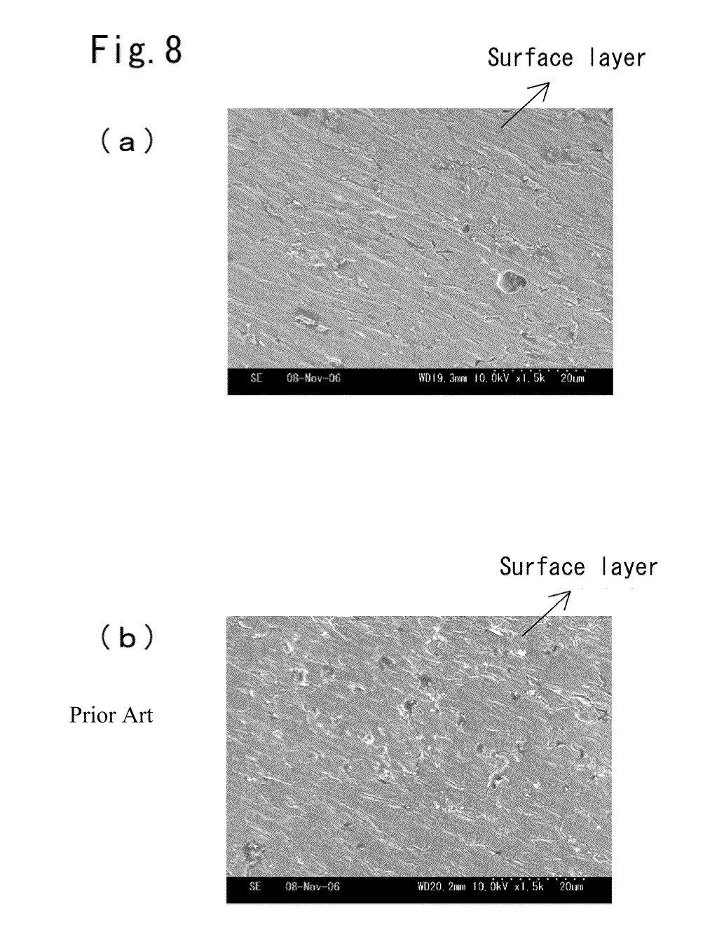

In the embodiment article, as shown in FIG. 8a, individual particles were small and had a compressed shape. Meanwhile, in the conventional disc, as shown in FIG. 8b, individual particles were large. By the evaluation at the portion γ, it was found that the gap between particles was not changed but the particles themselves were changed around the plate thickness center.

### <Portion δ>

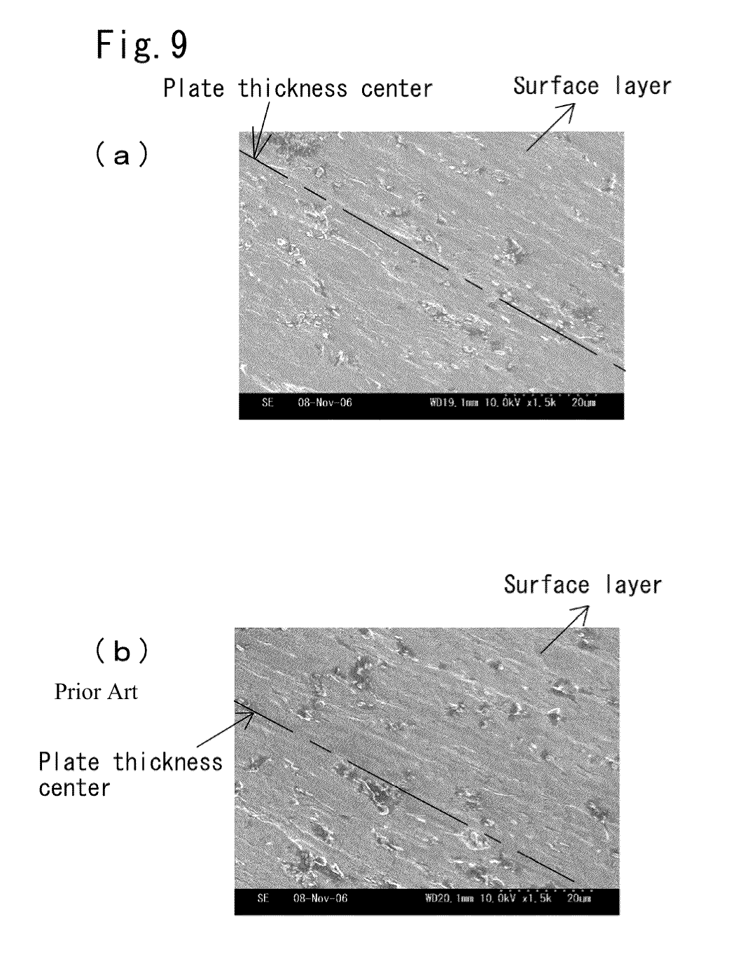

As shown in FIGS. 9a and 9b, no great difference was found between the embodiment article and the conventional article. By the evaluation at the portion δ, it was found that the influence of the high pressure did not reach the plate thickness center.

### <Portion ε>

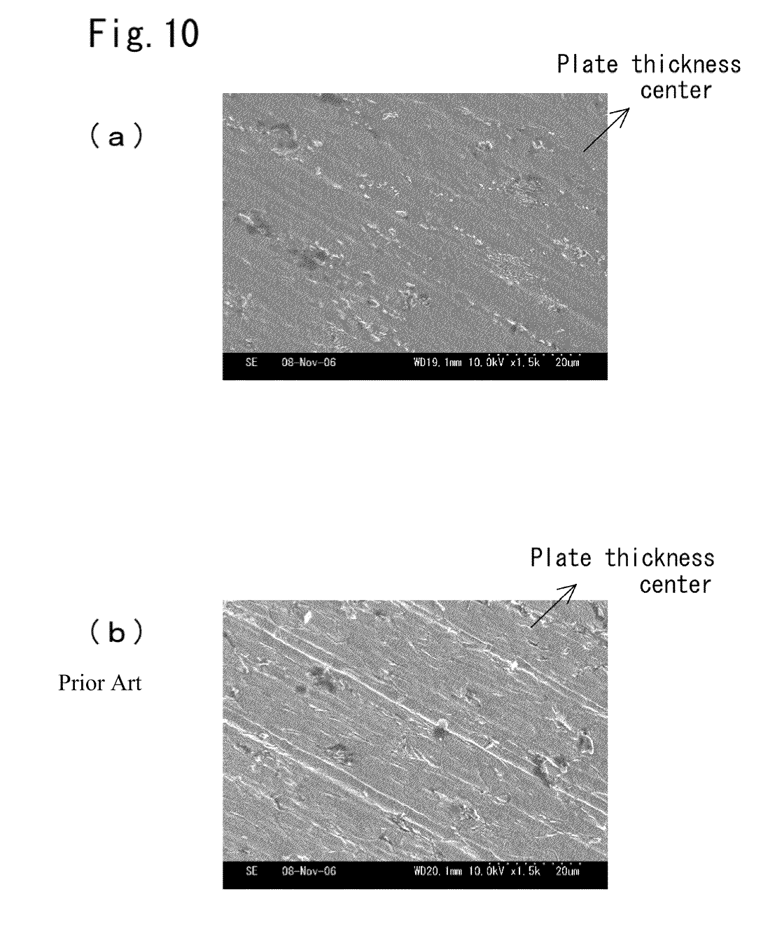

As shown in FIGS. 10a and 10b, no great difference was found between the embodiment article and the conventional article. By the evaluation at the portion ε, it was found that the influence of the high pressure did not reach the plate thickness center.

### <Portion ζ>

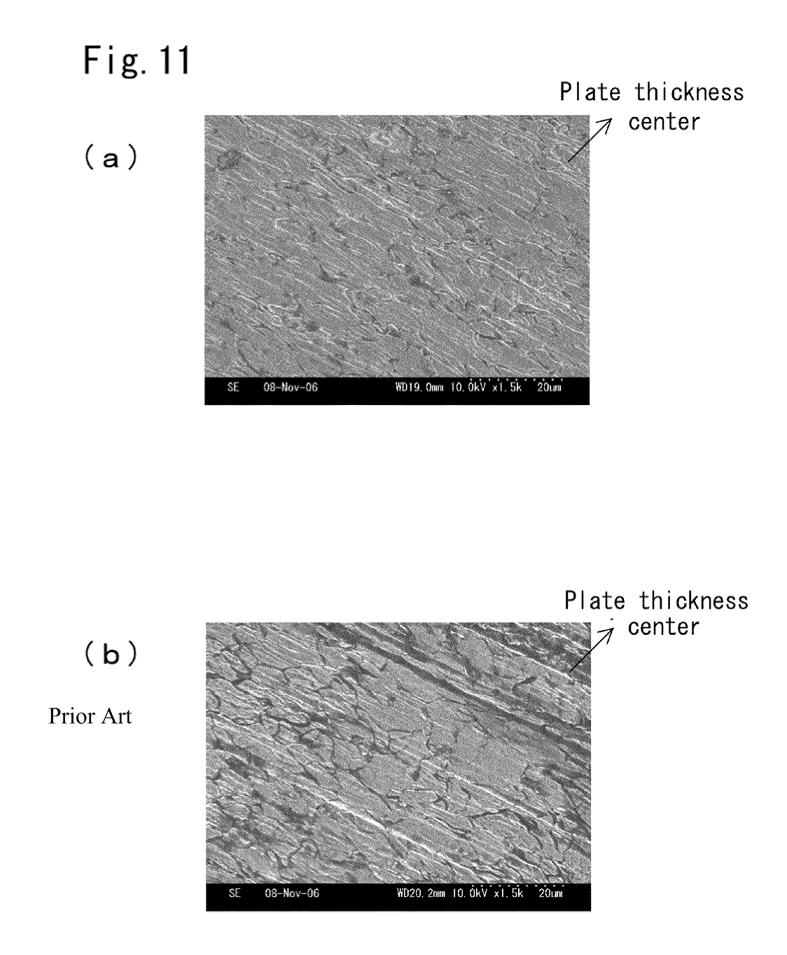

In the embodiment article, as shown in FIG. 11a, metal particles were compressed. Meanwhile, in the conventional disc, as shown in FIG. 11b, particles were not compressed at the portion close to the surface layer. By the evaluation at the portion ζ, it was found that the gap between particles and the shape of particles were changed by the high pressure applied in the present invention.

### <Portion η>

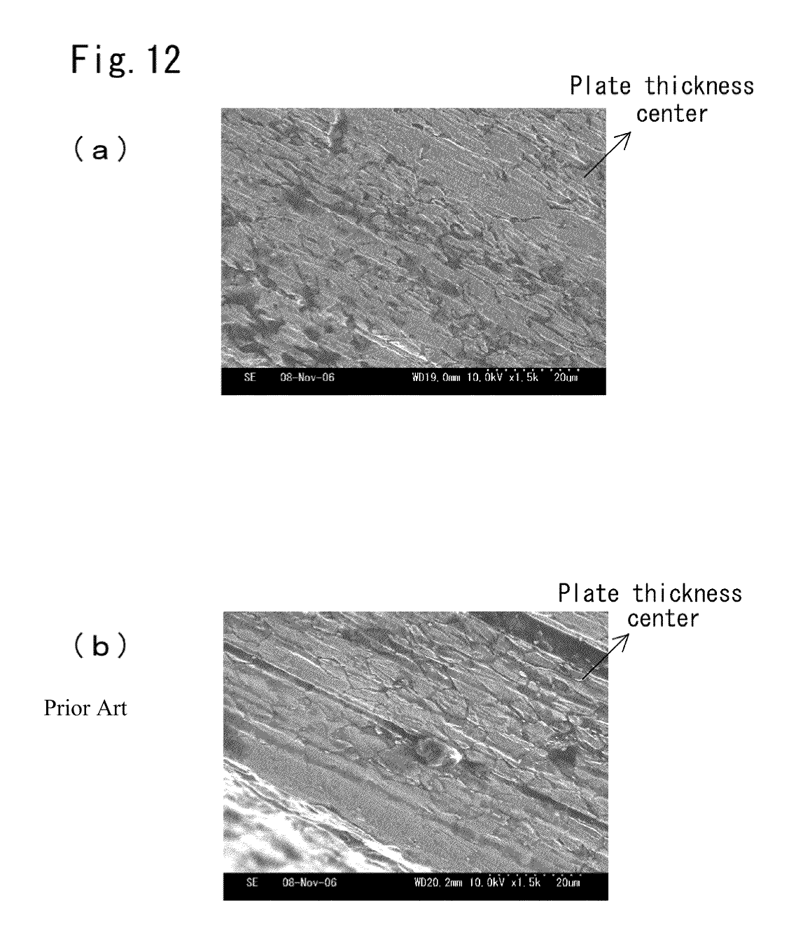

In the embodiment article, metal particles had a compressed shape, although the difference between the embodiment article and the conventional article was not so remarkable as at the portion α, as shown in FIGS. 12a and 12b.

Now, an automobile wheel 1b in accordance with the present invention will be described using a known bead fitting wheel as an example. Components common to those of the above automobile wheel 1a as a full-face wheel are given the same reference numerals to simplify or omit their descriptions.

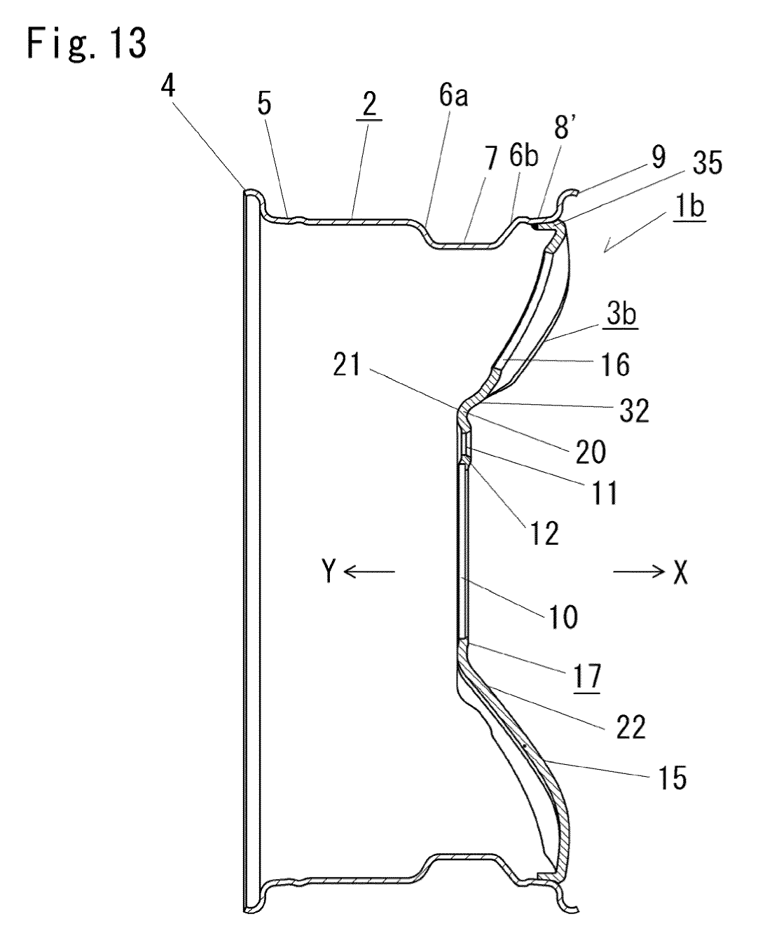

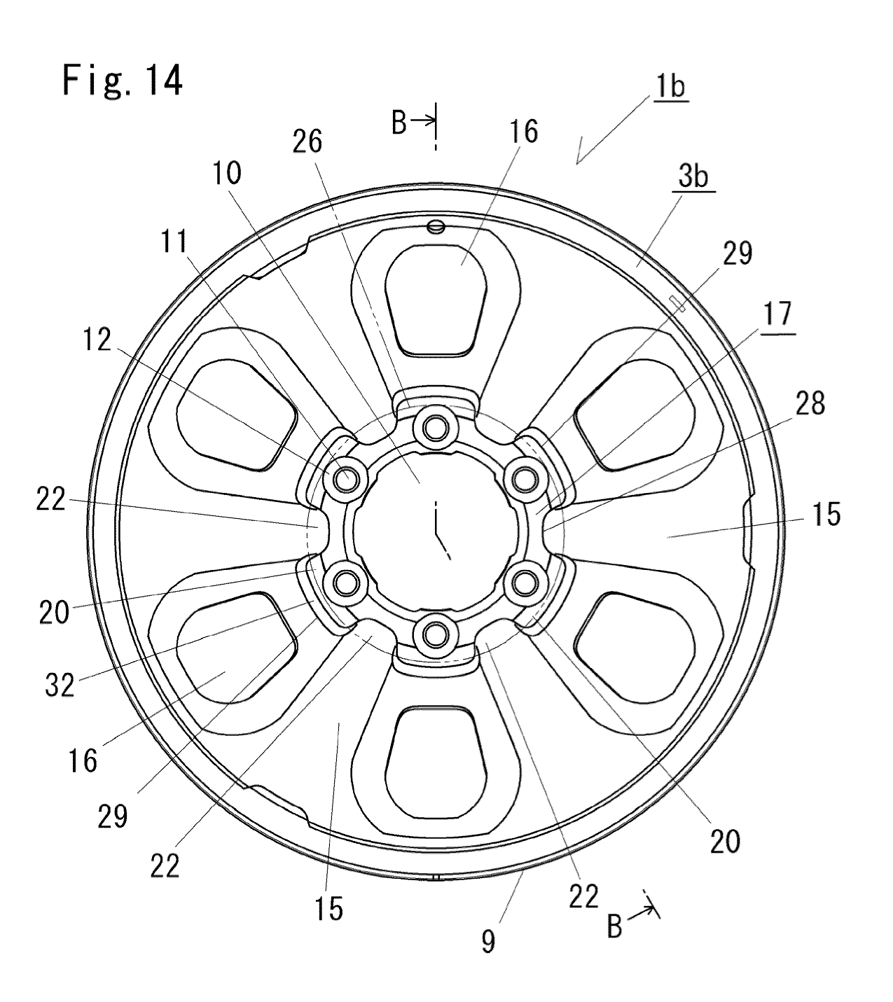

As shown in FIGS. 13 and 14, the automobile wheel 1b as a bead fitting wheel includes a rim 2 and a disc 3b. The rim 2 includes bead seats 5, 8′, at both sides in the axial direction, on which beads of a tire are seated. The bead seat 8′ positioned on the design surface side X serves as a fitting bead seat 8′. A design surface side flange 9 is formed continuously with the fitting bead seat 8′.

Meanwhile, the outer periphery of the disc 3b is bent toward the design surface back side Y to form a flange 35. The automobile wheel 1b is constructed by fitting the flange 35 of the disc 3b with the inner periphery of the fitting bead seat 8′ of the rim 2, and joining the fitted portion.

The disc 3b shown in FIGS. 13 and 14 includes six bolt holes 11 and six ornamental holes 16. Bulged projections 22 are formed at portions of spokes 15 on the hub hole 10 side. In the external shape of the disc 3b, the bolt holes 11, the hub surface rounded portions 20, and the ornamental holes 16 are arranged on the same line in the radial direction of the disc 3b. Also in the constitution, a plurality of hub surface rounded portions 20 are arranged at intervals on the imaginary circle 26, while bulged projections 22, which project to the design surface side X to a predetermined height with respect to the hub surface rounded portions 20, are arranged between adjacent hub surface rounded portions 20, 20.

Also in the automobile wheel 1b as a bead fitting wheel, all the plurality of hub surface rounded portions 20 formed in the disc 3b are subjected to a compression process for work-hardening, providing a compressive residual stress to improve the strength.

Discs 3c, 3d with other external shapes are further proposed. Respective embodiments are described below.

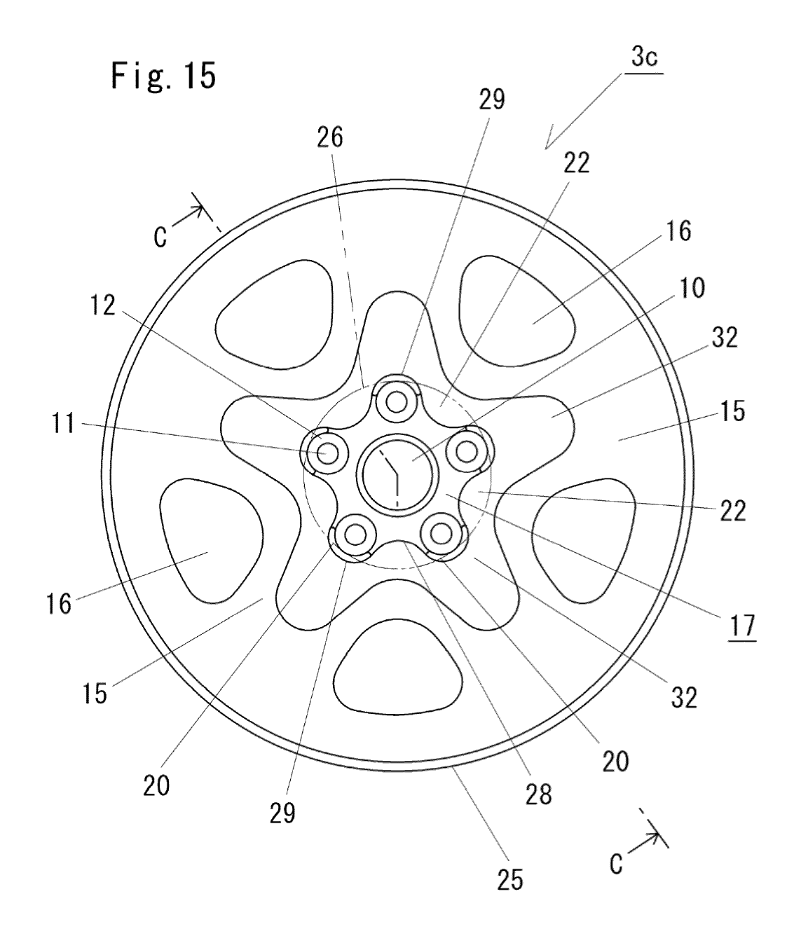

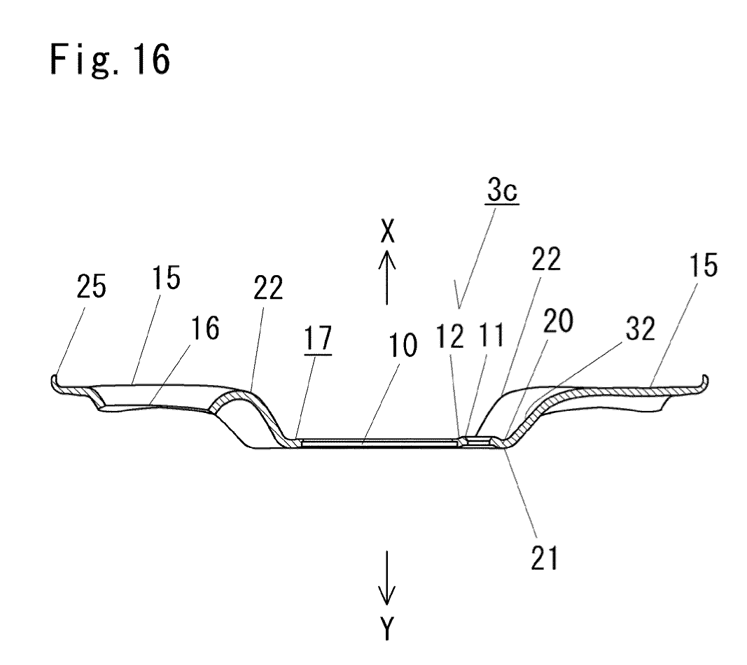

The disc 3c shown in FIGS. 15 and 16 includes five bolt holes 11 and five ornamental holes 16. In the external shape of the disc 3c, the bolt holes 11, the hub surface rounded portions 20, and the spokes 15 are arranged on the same line in the radial direction of the disc 3c. The spokes 15 rise relatively gently to the design surface side X toward the outer periphery, with their distal ends at substantially the same height as the surrounding areas of the ornamental holes 16. Also in the disc 3c, a plurality of hub surface rounded portions 20 are formed at intervals on an imaginary circle 26, while bulged projections 22, which project to the design surface side X to a predetermined height with respect to the hub surface rounded portions 20, are arranged between adjacent hub surface rounded portions 20, 20.

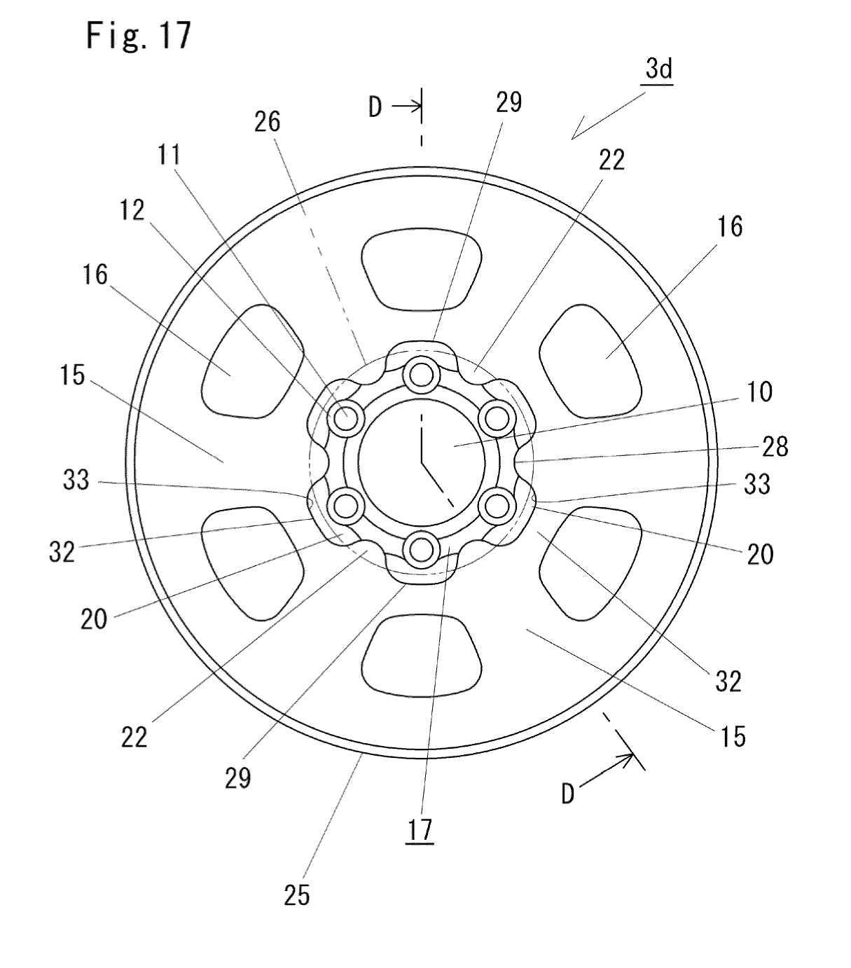

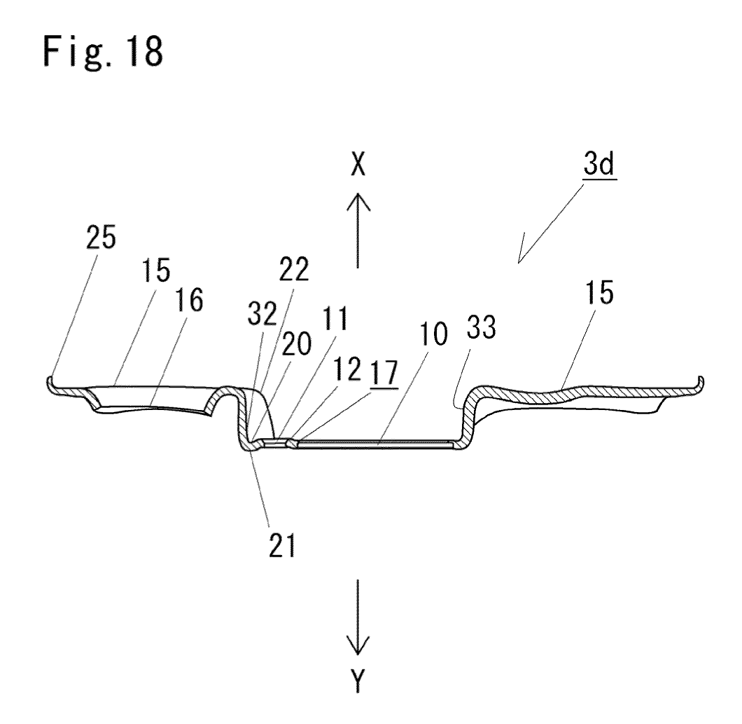

The disc 3d shown in FIGS. 17 and 18 includes six bolt holes 11 and six ornamental holes 16. In the external shape of the disc 3d, the bolt holes 11, the hub surface rounded portions 20, and the ornamental holes 16 are arranged on the same line in the radial direction of the disc 3b. Between the hub surface rounded portions 20 and the ornamental holes 16 are formed standing walls 33, which stand to the design surface side X substantially perpendicularly to the hub surface rounded portions 20, with the standing height maintained to the outer periphery of the disc 3d. Also in the disc 3d, a plurality of hub surface rounded portions 20 are formed at intervals on an imaginary circle 26, while bulged projections 22, which project to the design surface side X to a predetermined height with respect to the hub surface rounded portions 20, are arranged between adjacent hub surface rounded portions 20, 20.

The feature common to all the above discs 3a to 3d is that a plurality of hub surface rounded portions 20 are provided at intervals. Specifically, the bolt hole forming surface 17 in a gear shape as viewed from the front (see FIGS. 3, 14, 15 and 17) is formed inside the imaginary circle 26 provided around the hub hole 10, and the hub surface rounded portions 20 are respectively formed at a plurality of swelling arcuate portions 29, which swell radially outward and which constitute a part of an outer periphery 28 of the bolt hole forming surface 17. The bolt hole forming surface 17 in a gear shape as viewed from the front in accordance with the embodiments constitutes the gear-shaped annular surface in accordance with the present invention. In a disc including at least a bolt hole forming surface 17 in a gear shape as viewed from the front, a plurality of hub surface rounded portions 20 are formed at intervals, which tend to be subjected to stress concentration. Therefore, there is much significance in providing the hub surface rounded portions 20 with a compressive residual stress to enhance the strength.

In the discs 3a to 3d to which the present invention is applied, in general, the ratio of the length of the hub surface rounded portions 20 to the length of the gap between the hub surface rounded portions 20 may suitably be in the following range:
hub surface rounded portion 20 length: gap length=6:4 to
hub surface rounded portion 20 length: gap length=4:6
   The number of the bolt holes 11 may suitably be 4 to 6.

In the constitutions discussed above, a compressive residual stress is provided only to all the hub surface rounded portions 20. However, not only all the hub surface rounded portions 20 but also neighboring regions of the hub surface rounded portions 20 may be subjected to a compression process for work-hardening to be provided with a compressive residual stress. For example, all the outer rising portions 32, which are formed continuously with the outer peripheral sides of the hub surface rounded portions 20 and which are inclined to the design surface side X with respect to the hub surface rounded portions 20, may also be provided with a compressive residual stress by a compression process for work-hardening. Specifically, in the disc 3a shown in FIGS. 1 to 4, the outer rising portions 32 correspond to the base ends of the spokes 15, which are immediately on the outer side of the hub surface rounded portions 20. In the disc 3b shown in FIGS. 13 and 14, the outer rising portions 32 correspond to portions of the edges of the ornamental holes 16 on the hub hole 10 side, which are immediately on the outer side of the hub surface rounded portions 20. In the disc 3c shown in FIGS. 15 and 16, the outer rising portions 32 correspond to the base ends of the spokes 15, which are immediately on the outer side of the hub surface rounded portions 20. In the disc 3d shown in FIGS. 17 and 18, the outer rising portions 32 correspond to portions of the edges of the ornamental holes 16 on the hub hole 10 side, which are immediately on the outer side of the hub surface rounded portions 20.

In the constitutions discussed above, a pressing process using the dies 30a, 30b is adopted as the compression process for work-hardening all the hub surface rounded portions 20 and so forth. However, a shot peening process may be adopted as the compression process. Specifically, a known shot peening process may be applied to at least one side of all the hub surface rounded portions 20 and so forth. In the case where a shot peening process is applied only to the design surface back side of the hub surface rounded portions 20 and so forth, the design surface side is not wounded to be rough, and the design quality is not spoiled. In the case where a shot peening process is applied only to the design surface side of the hub surface rounded portions 20 and so forth, the strength of the hub surface rounded portions 20 and so forth can be improved more than the case where a shot peening process is applied only to the design surface back side.

The automobile wheels 1a, 1b in accordance with the present invention are not limited to the above embodiments, and may be modified appropriately without departing from the scope and spirit of the present invention. For example, the hub surface rounded portions 20 may be arranged on the imaginary circle 26 at regular intervals, or may be arranged not at regular intervals but separately in a well-balanced manner in accordance with certain rules.

1. An automobile wheel having a rim on which a tire is mountable and a disc joined to the rim, wherein the disc comprises:
a hub hole disposed in a center of the disc; and
a plurality of hub surface rounded portions for contacting a hub of an automobile, the hub surface rounded portions being formed at intervals on an imaginary circle provided around the hub hole and centered on an imaginary center corresponding to a center of the hub hole, and
wherein all the hub surface rounded portions are provided with a compressive residual stress by a compression process for work-hardening.

2. The automobile wheel according to claim 1,
wherein the disc is shaped by pressing a base material in a predetermined shape into a predetermined shape using a pair of shaping dies, and
the compression process for work-hardening the hub surface rounded portions is a pressing process including obtaining a disc in a predetermined shape and applying a high pressure to all the hub surface rounded portions.

3. The automobile wheel according to claim 1, wherein the compression process for work-hardening the hub surface rounded portions is a shot peening process performed on the hub surface rounded portions.

4. The automobile wheel according to claim 1, wherein the disc includes bulged projections formed between the hub surface rounded portions that are adjacent to each other in a direction along the imaginary circle provided around the hub hole, the bulged projections projecting to a design surface side with respect to the hub surface rounded portions and partially extending inwardly of the imaginary circle.

5. The automobile wheel according to claim 1, wherein the disc further comprises:
a gear-shaped annular surface formed inside the imaginary circle provided around the hub hole, with bolt holes formed circumferentially at regular intervals in the gear-shaped annular surface, and
wherein the hub surface rounded portions are formed at swelling arcuate portions constituting a part of an outer periphery of the gear-shaped annular surface.

6. The automobile wheel according to claim 1, wherein an outer periphery of the disc serves as a design surface side flange for supporting a bead of a tire from a side,
the rim includes a design surface back side flange for supporting a bead of the tire from a side at one end of the rim in an axial direction, and a joint at the other end, and
a back surface of the disc is joined to the joint.

7. The automobile wheel according to claim 1, wherein the rim includes bead seats, at both sides of the rim in an axial direction, on which beads of a tire are seated, with one of the bead seats serving as a fitting bead seat, and
the disc is fitted with the fitting bead seat.

8. The automobile wheel according to claim 1, wherein the disc includes the hub surface rounded portions and outer rising portions formed continuously with outer peripheral sides of the hub surface rounded portions and inclined to the design surface side with respect to the hub surface rounded portions, and
all the hub surface rounded portions and all the outer rising portions are provided with a compressive residual stress by a compression process for work-hardening.
